(19) United States
(12) Patent Application Publication
(10) Pub. No.: US 2020/0242813 A1
(43) Pub. Date: Jul. 30, 2020

(54) DISPLAY CONTROL DEVICE, DISPLAY CONTROL METHOD, AND DISPLAY SYSTEM

(71) Applicant: Mitsubishi Electric Corporation, Tokyo (JP)

(72) Inventors: Ayumi NISHIKAWA, Tokyo (JP); Yuki SUMIYOSHI, Tokyo (JP)

(73) Assignee: Mitsubishi Electric Corporation, Tokyo (JP)

(21) Appl. No.: 16/651,117

(22) PCT Filed: Oct. 20, 2017
(86) PCT No.: PCT/JP2017/037951

§ 371 Date: Mar. 26, 2020

(51) Int. Cl. G06T 11/00; G06T 7/50; G06T 7/70

(52) U.S. Cl. CPC G06T 11/00; G06T 7/50; G06T 2200/24; G06T 2207/10028; G06T 7/70

(57) ABSTRACT

A display control method comprising: detecting a real object in real scenery; acquiring a to-be-hidden region in the virtual object where the real object is placed in front of a superimposing position of the virtual object, on a basis of a depth relationship between the superimposing positing and the real object, and a positional relationship on a screen between the superimposing position and the real object; calculating a recognizability used for determining whether information indicated by the virtual object is recognizable when the to-be-hidden region is hidden, and determining whether the recognizability is equal to or greater than a threshold value; and generating another virtual object by hiding the to-be-hidden region of the virtual object when the recognizability is equal to or greater than the threshold value, and generating another virtual object by changing a display form of the virtual object when the recognizability is less than the threshold value.

### TECHNICAL FIELD

The present invention relates to a display control device, a display control method and a display system.

### BACKGROUND ART

AR (Augmented Reality) display systems are in widespread use, which are equipped in vehicles or the like, and display a virtual object such as a navigation arrow or the like to be superimposed on real scenery.

In Patent Literature 1, a vehicle navigation system is disclosed in which, when a forward vehicle as an obstacle and a navigation arrow as an information communication piece overlap each other, the overlapped region in the information communication piece is deleted. According to such a configuration, it is possible to visually recognize both the forward vehicle and the navigation arrow without the forward vehicle being obstructed by the navigation arrow.

### CITATION LIST

### Patent Literature

Patent Literature 1: Japanese Patent Application Laid-open No. 2005-69799 ([0120], FIG. 20)

### SUMMARY OF INVENTION

### Technical Problem

As described above, in the vehicle navigation system disclosed in Patent Literature 1, with respect to a region where the vehicle and the navigation arrow overlap each other, processing of deleting the overlap region from the navigation arrow (hereinafter, referred to as “hiding processing”) is performed. However, in the hiding processing, details of the overlap region, such as the area, the position or the like, of the region where a real object and a virtual object overlap each other are not considered. Accordingly, for example, there is a problem that, when the area of the overlap region is large, the area of the hidden region becomes large, so that information indicated by the virtual object becomes unclear.

This invention has been made to solve the problem as described above, and an object thereof is to provide a display control device, a display control method and a display system which prevent the information indicated by a virtual object from becoming unclear, even when the hiding processing is performed on a region where the virtual object and a real object overlap each other.

### Solution to Problem

A display control device according to the present invention controls a display device that superimposes a virtual object on real scenery, and includes: an external information acquisition unit detecting a real object existing in the real scenery; a to-be-hidden region acquisition unit acquiring, on a basis of a depth relationship between a superimposing position of the virtual object and the real object, and a positional relationship on a display screen of the display device between the superimposing position of the virtual object and the real object, a to-be-hidden region that is a region in the virtual object where the real object is to be placed in front of the superimposing position of the virtual object; a recognizability determination unit calculating a recognizability used for determining whether or not information indicated by the virtual object is recognizable when the to-be-hidden region is hidden, and determining whether or not the recognizability is equal to or greater than a threshold value; and a control unit generating, when the recognizability is equal to or greater than the threshold value, another virtual object which is obtained by hiding the to-be-hidden region of the virtual object, and generating, when the recognizability is less than the threshold value, another virtual object which is obtained by changing a display form of the virtual object.

### Advantageous Effects of Invention

According to the invention, it is possible to provide a display control device, a display control method and a display system which prevent the information indicated by a virtual object from becoming unclear, even when the hiding processing is performed on a region where the virtual object and a real object overlap each other.

### BRIEF DESCRIPTION OF DRAWINGS

FIG. 1 is a block diagram showing a configuration of a display control device according to Embodiment 1.

FIG. 2 is a diagram for illustrating a virtual object after hiding processing.

FIG. 3 is a diagram for illustrating image information of a virtual object and superimposing-position information of the virtual object.

FIG. 4 is another diagram for illustrating image information of a virtual object and superimposing-position information of the virtual object.

FIG. 5 is a flowchart for illustrating operations of the display control device according to Embodiment 1.

FIG. 6A is a flowchart for illustrating virtual-object generation processing according to Embodiment 1.

FIG. 6B is a flowchart for illustrating the virtual-object generation processing according to Embodiment 1.

FIG. 7 is a diagram showing a case where it is determined that there is a to-be-hidden region.

FIG. 8 is a diagram showing an example of the virtual object after the hiding processing.

FIG. 9 is a diagram showing an example of the virtual object in a case where its display form is changed.

FIG. 10 is a block diagram showing a configuration of a display control device according to Embodiment 2.

FIG. 11 is a diagram showing an example of setting of importance degrees in a virtual object.

FIG. 12A is a flowchart for illustrating virtual-object generation processing according to Embodiment 2.

FIG. 12B is a flowchart for illustrating the virtual-object generation processing according to Embodiment 2.

FIG. 13 is a diagram showing a case where a head-side region in an arrow is determined to become a to-be-hidden region.

FIG. 14 is a diagram showing a case where a head-side region in an arrow is determined not to become a to-be-hidden region.

FIG. 15 is a flowchart for illustrating virtual-object generation processing according to Embodiment 3.

FIG. 16 is a diagram showing a case where a user uses a function of highlighting a nearby vehicle or a nearby pedestrian.

FIG. 17 is a diagram showing an area of a virtual object before hiding processing.

FIG. 18 is a diagram showing an area of the virtual object after hiding processing.

FIG. 19 is a flowchart for illustrating virtual-object generation processing according to Embodiment 4.

FIG. 20 is a diagram for illustrating an area of an important region in a virtual object before hiding processing.

FIG. 21 is a diagram for illustrating an area of an important region in the virtual object after hiding processing.

FIG. 22A is a flowchart for illustrating virtual-object generation processing according to Embodiment 5.

FIG. 22B is a flowchart for illustrating the virtual-object generation processing according to Embodiment 5.

FIG. 23 is a diagram for illustrating importance degrees of respective pixels.

FIG. 24 is a diagram for illustrating importance degrees in a to-be-hidden region.

FIG. 25 is a diagram for illustrating a recognizability of a virtual object after hiding processing.

FIG. 26 is a flowchart for illustrating virtual-object generation processing according to Embodiment 6.

FIG. 27 is a diagram showing an example of a region suitable for virtual object display.

FIG. 28 is a diagram showing another example of a region suitable for virtual object display.

FIG. 29 is a diagram for illustrating a region (effective region) suitable for displaying an important region in a virtual object.

FIG. 30 is a diagram showing an example of displacing the important region in the virtual object to an effective region.

FIG. 31 is a diagram showing another example of displacing the important region in the virtual object to an effective region.

FIG. 32 is a diagram showing an example of prestored multiple virtual objects.

FIG. 33A and FIG. 33B are diagrams each showing a hardware configuration example of a display control device.

### DESCRIPTION OF EMBODIMENTS

### Embodiment 1

Hereinafter, for illustrating the invention in more detail, some embodiments for carrying out the invention will be described with reference to the accompanying drawings.

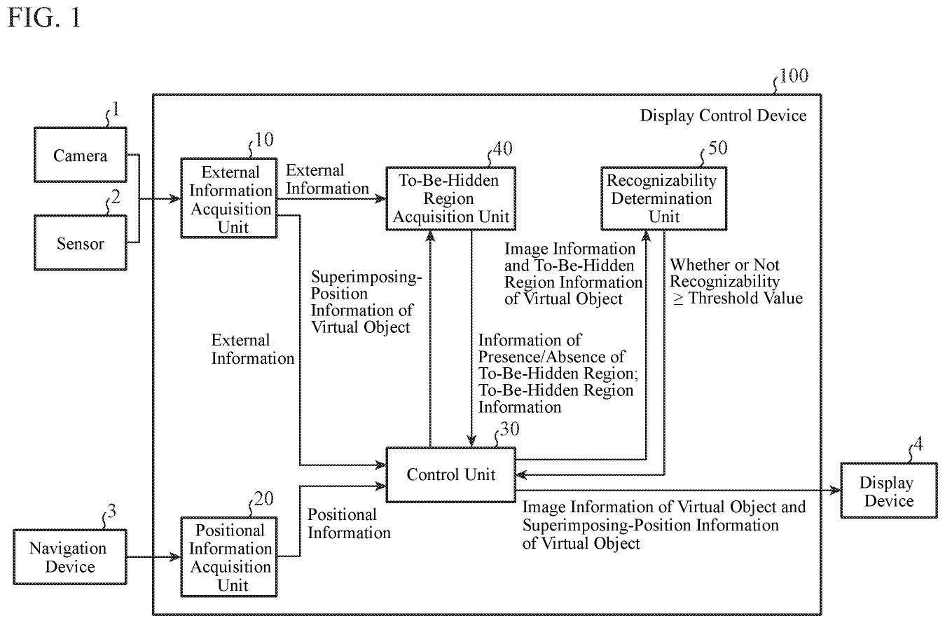

FIG. 1 is a block diagram showing a configuration of a display control device 100 according to Embodiment 1.

The display control device 100 is configured to include an external information acquisition unit 10, a positional information acquisition unit 20, a control unit 30, a to-be-hidden region acquisition unit 40, a recognizability determination unit 50 and the like.

The display control device 100 is connected to a camera 1, a sensor 2, a navigation device 3, and a display device 4. The display control device 100 is, for example, a device equipped in a vehicle or a mobile terminal to be brought into a vehicle while being carried by a passenger. The mobile terminal is, for example, a portable navigation device, a tablet PC or a smartphone.

In the above, it is described that the display control device 100 is a device equipped in a vehicle or to be brought into a vehicle; however, this is not limitative, and the display control device may be used in another conveyance provided with the camera 1, the sensor 2, the navigation device 3 and the display device 4. Further, if a mobile terminal includes the display control device 100, the camera 1, the sensor 2, the navigation device 3 and the display device 4, the display control device can be used during walking without being brought into a vehicle.

The display control device 100 controls the display device 4 that superimposes a virtual object on real scenery. In Embodiment 1, description will be made about a case where a head-up display is used as the display device 4.

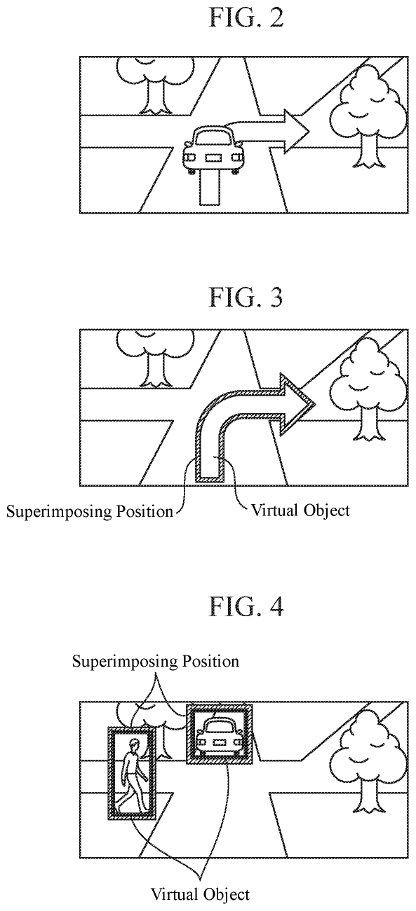

FIG. 2 is a diagram for illustrating a virtual object after the hiding processing.

In the case shown in FIG. 2, the virtual object is a navigation arrow. FIG. 2 shows a situation where a vehicle that is an actual object (hereinafter, referred to as a real object) is placed between a current position of a user and a depth-direction position of the virtual object visually recognized by the user.

The display control device 100 generates a virtual object in which a region in the virtual object overlapped with the real object (to-be-hidden region) is hidden. In the navigation arrow shown in FIG. 2, the region that is overlapped with the vehicle is subjected to the hiding processing.

The display control device 100 according to Embodiment 1 calculates a recognizability of the virtual object after the hiding processing, and changes the display form of the virtual object when the recognizability is less than a threshold value.

The recognizability is a value used for determining whether or not information indicated by the virtual object is recognizable by the user. The recognizability varies depending, for example, on a hidden size of the virtual object. The smaller the hidden size of the virtual object is, the larger the recognizability is, and the larger the hidden size of the virtual object is, the smaller the recognizability is.

The external information acquisition unit 10 generates external information indicating a position, a size, etc. of the real object existing in real scenery, and outputs the generated external information to the control unit 30 and the to-be-hidden region acquisition unit 40.

The external information acquisition unit 10 generates the external information indicating a position, a size, etc. of the real object existing in the real scenery, by analyzing, for example, image data of the real scenery acquired from the camera 1.

The external information acquisition unit 10 generates the external information indicating a position, a size, etc. of the real object existing in the real scenery, by analyzing, for example, sensor data acquired from the sensor 2.

Note that the generation method of the external information by the external information acquisition unit is not limited to these methods, and another known technique may be used.

The positional information acquisition unit 20 acquires positional information from the navigation device 3.

In the positional information, information of a current position of the user is included. Further, when a navigation function is used, information of the position of an intersection being a navigation target, information of the position of a building being a navigation target, or the like, are included in the positional information. The positional information acquisition unit 20 outputs the acquired positional information to the control unit 30.

On the basis of the external information acquired from the external information acquisition unit 10, the positional information acquired from the positional information acquisition unit 20, the functions to be provided to the user (navigation, highlighting of a real object, etc.) and the like, the control unit 30 generates image information of a virtual object and superimposing-position information of the virtual object. The virtual object is an image or the like which is prepared in advance by a PC or the like.

FIG. 3 is a diagram for illustrating the image information of a virtual object and the superimposing-position information of the virtual object.

When the user uses the navigation function, the image information of the virtual object indicates, for example, a navigation arrow as shown in FIG. 3. In this case, the superimposing-position information of the virtual object is information indicating a position where the navigation arrow is superimposed on the real scenery. In the information indicating the position, information of the position with respect to each of the vertical direction, horizontal direction, and depth direction are included.

On the basis of a relationship between the current position of the user and the superimposing position of the virtual object, the control unit 30 adjusts the position, size, etc. of the virtual object visually recognized through a display screen of the display device 4 so that the virtual object is superimposed at the superimposing position of the virtual object when the user views the virtual object together with the real scenery.

On the basis of the information of the current position of the user and the information of the position of the intersection being a navigation target that are acquired from the positional information acquisition unit 20, the control unit 30 acquires a distance from the current position of the user to the position of the intersection being a navigation target. On the basis of the distance, the control unit 30 adjusts a position, size, etc. of the navigation arrow visually recognized through the display screen of the display device 4 so that the navigation arrow is superimposed on the intersection being a navigation target.

FIG. 4 is another diagram for illustrating the image information of a virtual object and the superimposing-position information of the virtual object.

When the user uses the function of highlighting a nearby vehicle or a nearby pedestrian, the image information of the virtual object indicates, for example, each frame shape as shown in FIG. 4. In this case, the superimposing-position information of the virtual object is information about the position where the frame shape is superimposed on the real scenery. In the information about that position, information of position with respect to each of the vertical direction, horizontal direction, and depth direction is included.

The control unit 30 outputs the generated superimposing-position information of the virtual object to the to-be-hidden region acquisition unit 40.

On the basis of the external information acquired from the external information acquisition unit 10 and the superimposing-position information of the virtual object acquired from the control unit 30, the to-be-hidden region acquisition unit 40 acquires a positional relationship and a depth relationship between the superimposing position of the virtual object and the real object.

The positional relationship is a relationship in the vertical and horizontal positions on the display screen of the display device 4, when the user views the superimposing position of the virtual object and the real object together by means of the display device 4.

The depth relationship is a positional relationship in the depth direction between the superimposing position of the virtual object and the real object, when the user views the superimposing position of the virtual object and the real object together by means of the display device 4.

On the basis of the positional relationship and the depth relationship, the to-be-hidden region acquisition unit 40 determines whether or not there is a region (corresponding to a to-be-hidden region) where the superimposing position of a virtual object and a real object overlap each other when viewed from the user, and where the real object in the real scenery is placed in front of the superimposing position of the virtual object.

The to-be-hidden region acquisition unit 40 outputs information indicating the result of that determination to the control unit 30. At this time, the to-be-hidden region acquisition unit 40, in the case of outputting information indicating that there is a to-be-hidden region, outputs information indicating the to-be-hidden region (hereinafter, referred to as to-be-hidden region information) together to the control unit 30.

In a case where the control unit 30 acquires the information indicating that there is no to-be-hidden region from the to-be-hidden region acquisition unit 40, the control unit 30 outputs the image information of the virtual object and the superimposing-position information of that virtual object to the display device 4. This is because the hiding processing is unnecessary.

On the other hand, in a case where the control unit 30 acquires the information indicating that there is a to-be-hidden region from the to-be-hidden region acquisition unit 40 and the to-be-hidden region information, the control unit 30 outputs the image information of the virtual object and the to-be-hidden region information to the recognizability determination unit 50.

On the basis of the image information of the virtual object and the to-be-hidden region information acquired from the control unit 30, the recognizability determination unit 50 calculates the recognizability of the virtual object after the hiding processing. The hiding processing is accomplished by deletion or the like, of a region represented by the to-be-hidden region information from a region represented by the image information of the virtual object.

The recognizability determination unit 50 determines whether or not the recognizability of the virtual object after the hiding processing is equal to or greater than a predetermined threshold value. The recognizability determination unit 50 outputs information indicating the result of that determination to the control unit 30.

In a case where the control unit 30 acquires, from the recognizability determination unit 50, the information indicating that the recognizability of the virtual object after the hiding processing is equal to or greater than the threshold value, the control unit 30 outputs the image information of the virtual object after the hiding processing, and the superimposing-position information of the that virtual object, to the display device 4.

On the other hand, in a case where the control unit 30 acquires, from the recognizability determination unit 50, the information indicating that the recognizability is less than the threshold value, the control unit 30 changes the display form of the virtual object before the hiding processing. This change in the display form is made in order to put the virtual object into a state having no to-be-hidden region, or to make the recognizability of the virtual object after the hiding processing to be equal to or greater than the threshold value.

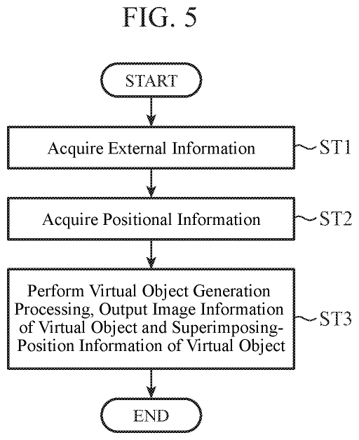

FIG. 5 is a flowchart for illustrating operations of the display control device 100 according to Embodiment 1. With reference to FIG. 5, the operations of the display control device 100 according to Embodiment 1 will be described.

On the basis of the image data acquired from the camera 1 or the sensor data acquired from the sensor 2, the external information acquisition unit 10 detects a real object existing in the real scenery to thereby acquire the external information indicating a position, a size, etc. of the real object (Step ST1). The external information acquisition unit 10 outputs the external information to the control unit 30 and the to-be-hidden region acquisition unit 40.

The positional information acquisition unit 20 acquires the positional information from the navigation device 3 (Step ST2). The positional information acquisition unit 20 outputs the positional information to the control unit 30.

The control unit 30 performs virtual-object generation processing, and outputs the image information of the thus-generated virtual object and the superimposing-position information of that virtual object to the display device 4 (Step ST3).

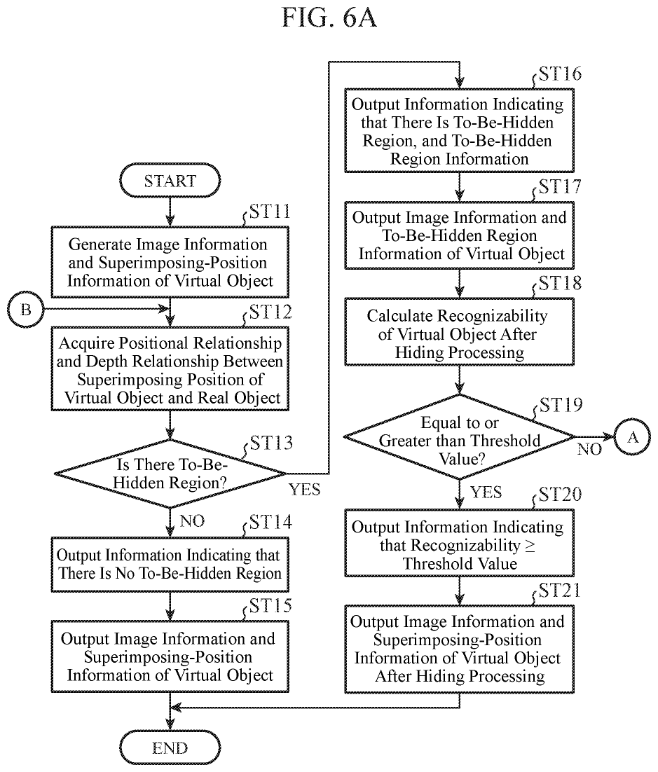

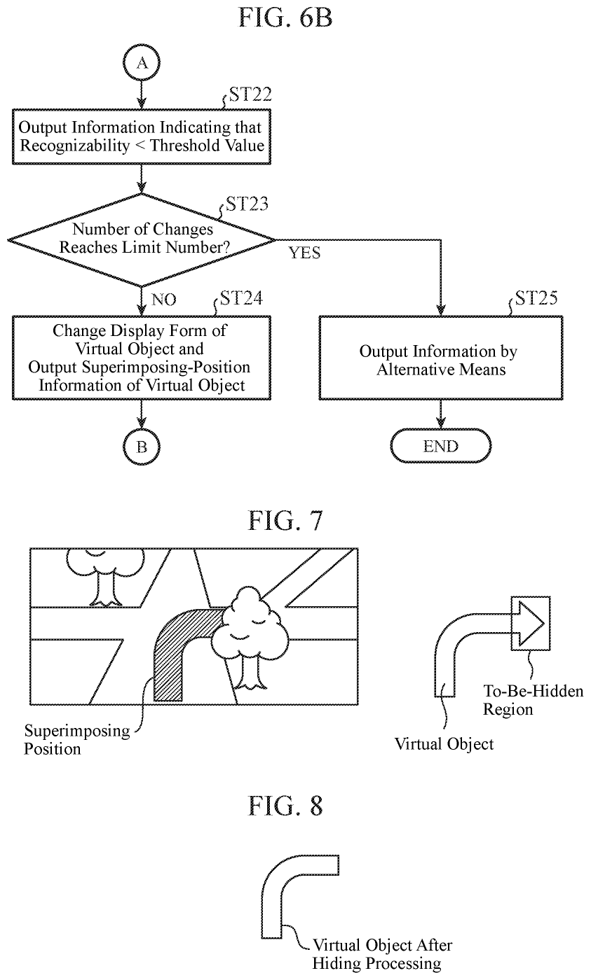

FIG. 6A and FIG. 6B are each a flowchart for illustrating the virtual-object generation processing shown in Step ST3 of FIG. 5.

On the basis of the external information acquired from the external information acquisition unit 10, the positional information acquired from the positional information acquisition unit 20, the functions to be provided to the user, and the like, the control unit 30 generates the image information of the virtual object and the superimposing-position information of that virtual object (Step ST11). The control unit 30 outputs the superimposing-position information of the virtual object to the to-be-hidden region acquisition unit 40.

On the basis of the external information acquired from the external information acquisition unit and the superimposing-position information of the virtual object acquired from the control unit 30, the to-be-hidden region acquisition unit 40 acquires a positional relationship and a depth relationship between the superimposing position of the virtual object and the real object (Step ST12).

On the basis of the positional relationship and the depth relationship, the to-be-hidden region acquisition unit 40 determines whether or not there is a region (corresponding to a to-be-hidden region) where the superimposing position of the virtual object and the real object overlap each other when viewed from the user, and where the real object in the real scenery is to be placed in front of the superimposing position of the virtual object (Step ST13). FIG. 7 is a diagram showing a situation where the to-be-hidden region acquisition unit 40 determines that there is a to-be-hidden region.

When it is determined that there is no to-be-hidden region (Step ST13; NO), the to-be-hidden region acquisition unit 40 outputs the information indicating that there is no to-be-hidden region to the control unit 30 (Step ST14).

In a case where the control unit 30 acquires the information indicating that there is no to-be-hidden region from the to-be-hidden region acquisition unit 40, the control unit 30 outputs the image information of the virtual object and the superimposing-position information of that virtual object to the display device 4 (Step ST15).

In Step ST13, when it is determined that there is a to-be-hidden region (Step ST13; YES), the to-be-hidden region acquisition unit 40 outputs the information indicating that there is a to-be-hidden region and the to-be-hidden region information to the control unit 30 (Step ST16).

In a case where the control unit 30 acquires, from the to-be-hidden region acquisition unit 40, the information indicating that there is a to-be-hidden region and the to-be-hidden region information, the control unit 30 outputs the image information of the virtual object and the to-be-hidden region information to the recognizability determination unit 50 (Step ST17).

On the basis of the image information of the virtual object and the to-be-hidden region information, the recognizability determination unit 50 calculates the recognizability of the virtual object after the hiding processing (Step ST18). FIG. 8 is a diagram showing an example of the virtual object after the hiding processing.

The recognizability determination unit 50 determines whether or not the recognizability of the virtual object after the hiding processing is equal to or greater than the predetermined threshold value (Step ST19).

The recognizability may be set within any given range. In the following description, the maximum value of the recognizability is set to 100 and the minimum value of the recognizability is set to 0.

The threshold value for the recognizability may be set to any value by which it is possible to determine whether or not the user can recognize the information indicated by the virtual object. In the following description, it is assumed that the threshold value is set to a value between 1 and 99. The threshold value for the recognizability may be set to a fixed value for all virtual objects, and may be set to a value that is different depending on the type of the virtual object.

When the threshold value for the recognizability is set to 80, the recognizability determination unit 50 determines in Step ST19 whether or not the recognizability of the virtual object after the hiding processing is equal to or greater than 80.

The recognizability determination unit 50, when it is determined that the recognizability of the virtual object after the hiding processing is equal to or greater than the predetermined threshold value (Step ST19; YES), outputs information indicating that the recognizability is equal to or greater than the threshold value to the control unit 30 (Step ST20). In a case where the control unit 30 acquires, from the recognizability determination unit 50, the information indicating that the recognizability is equal to or greater than the threshold value, the control unit 30 outputs the image information of the virtual object after the hiding processing, and the superimposing-position information of that virtual object, to the display device 4 (Step ST21).

The recognizability determination unit 50, when it is determined in Step ST19 that the recognizability of the virtual object after the hiding processing is less than the predetermined threshold value (Step ST19; NO), outputs information indicating that the recognizability is less than the threshold value, to the control unit 30 (Step ST22).

In a case where the control unit 30 acquires, from the recognizability determination unit 50, the information indicating that the recognizability is less than the threshold value, the control unit 30 determines whether or not the number of times that the display form of the virtual object is changed (number of changes) reaches a limit number (Step ST23). The limit number may be set to any value.

When the control unit 30 determines that the number of changes does not reach the limit number (Step ST23; NO), the control unit 30 changes the display form of the virtual object and generates the superimposing-position information of the virtual object after the change of the display form, and then outputs the superimposing-position information of that virtual object to the to-be-hidden region acquisition unit 40 (Step ST24). When the processing in Step ST24 is completed, the flow returns again to the processing in Step ST12.

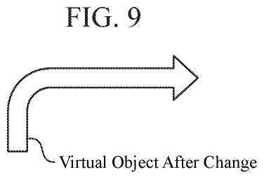

FIG. 9 is a diagram showing an example of the virtual object in the case where the display form thereof is changed by the control unit 30.

When the control unit 30 determines in Step ST23 that the number of changes reaches the limit number (Step ST23; YES), the control unit 30 outputs information by using alternative means (Step ST25). Examples of such an alternative means include, outputting information to a display unit (not shown) of the navigation device 3, outputting information by sound/voice through an unshown speaker, and the like.

As described above, the display control device 100 according to Embodiment 1 controls the display device 4 that superimposes a virtual object on real scenery, and includes: the external information acquisition unit 10 detecting a real object existing in the real scenery; the to-be-hidden region acquisition unit 40 acquiring, on the basis of a depth relationship between a superimposing position of the virtual object and the real object, and a positional relationship on a display screen of the display device 4 between the superimposing position of the virtual object and the real object, a to-be-hidden region that is a region in the virtual object where the real object is to be placed in front of a superimposing position of the virtual object; the recognizability determination unit 50 calculating a recognizability used for determining whether or not information indicated by the virtual object is recognizable when the to-be-hidden region is hidden, and determining whether or not the recognizability is equal to or greater than a threshold value; and the control unit 30 generating, when the recognizability is equal to or greater than the threshold value, another virtual object which is obtained by hiding the to-be-hidden region of the virtual object, and generating, when the recognizability is less than the threshold value, another virtual object which is obtained by changing a display form of the virtual object. Due to this configuration, it is possible to provide a display control device which prevents the information indicated by the virtual object from being unclear, even when the hiding processing is performed on a region where the real object and the virtual object overlap each other.

Further, according to Embodiment 1, even when the hiding processing is performed for causing the virtual object to be seen as if it is displayed behind the real object existing in the real scenery, the information of the virtual object is not lost. Thus, the user can properly understand the information indicated by the virtual object. Further, it is possible to prevent the user from having a feeling of discomfort by visually recognizing the virtual object or the like with a large area subjected to the hiding processing.

In the above, the description the case is described in which the user visually recognizes the real scenery through a see-through type display such as a head-up display or the like. However, it is not limited thereto, and this invention may be used in a case where the user views a screen image of the real scenery displayed on a head-mounted display. Further, the invention may be used in a case where the user views the real scenery displayed on a center display in a vehicle, a screen of a smartphone, or the like.

### Embodiment 2

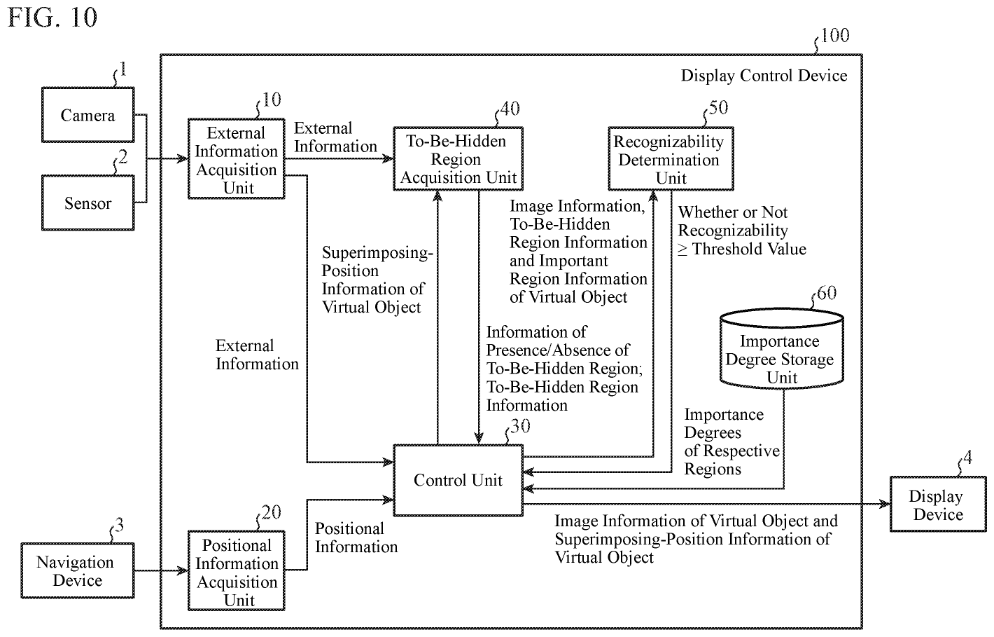

FIG. 10 is a block diagram showing a configuration of a display control device 100 according to Embodiment 2. For the components having functions that are the same as or equivalent to those of the components described in Embodiment 1, description thereof will be omitted or simplified.

The display control device 100 according to Embodiment 2 includes an importance degree storage unit 60.

With respect to the case where one virtual object is divided into multiple regions, importance degrees of these respective regions are stored in the importance degree storage unit 60. The importance degrees are preset for the respective regions, and any given values may be set therefor. In the virtual object, the importance degree is set high for a characteristic region and is set low for a non-characteristic region. The sum of the importance degrees in a virtual object as a whole is set to be equal to a predetermined maximum value of the recognizability.

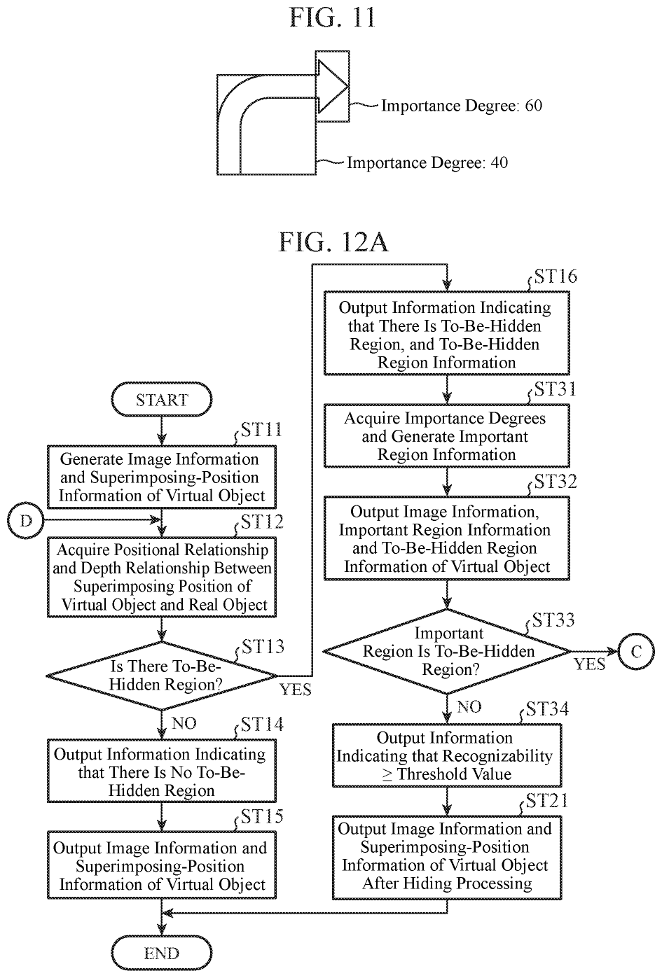

FIG. 11 is a diagram showing an example of the setting of the importance degrees in a virtual object. When the virtual object is a navigation arrow, it is divided into, for example, two regions of a head-side region in the arrow and a region in the arrow other than the head-side region, and the importance degrees of the respective regions are stored in the importance degree storage unit 60. The head-side region in the arrow indicates the direction to travel and corresponds to a characteristic region. Thus, the importance degree of the head-side region in the arrow is set higher than that of the region in the arrow other than the head-side region. In FIG. 11, the importance degree of the head-side region in the arrow is set to 60, and the importance degree of the region in the arrow other than the head-side region is set to 40.

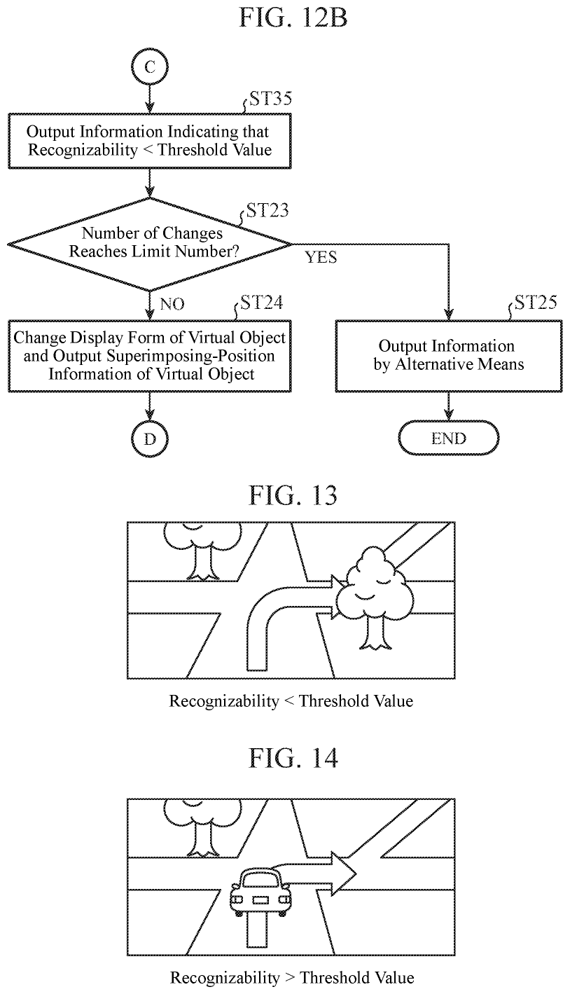

With reference to the flowcharts shown in FIG. 12A and FIG. 12B, virtual object generation processing performed by the display control device 100 according to Embodiment 2 will be described.

The steps from Step ST11 to Step ST16 are the same as those in FIG. 6A, so that duplicative description thereof will be omitted.

In a case where the control unit 30 acquires, from the to-be-hidden region acquisition unit 40, the information indicating that there is a to-be-hidden region and the to-be-hidden region information, the control unit acquires the importance degrees of the respective regions in the virtual object from the importance degree storage unit 60, and determines the region having the highest importance degree (important region) by comparing the importance degrees of the respective regions in the virtual object with each other, to thereby generate important region information indicating the important region (Step ST31). The control unit 30 outputs the image information of the virtual object, the important region information and the to-be-hidden region information acquired from the to-be-hidden region acquisition unit 40, to the recognizability determination unit 50 (Step ST32).

The recognizability determination unit 50 determines whether or not the important region in the virtual object becomes the to-be-hidden region (Step ST33).

The recognizability determination unit 50, when it is determined that the important region in the virtual object does not become a to-be-hidden region (Step ST33: NO), sets the recognizability of the virtual object after the hiding processing to the maximum value “100”, and outputs the information indicating that the recognizability is equal to or greater than the threshold value, to the control unit 30 (Step ST34). Step ST21 is the same as that in FIG. 6A, so that duplicative description thereof will be omitted.

On the other hand, when it is determined that the important region in the virtual object becomes the to-be-hidden region (Step ST33: YES), the recognizability determination unit 50 sets the recognizability of the virtual object after the hiding processing to the minimum value “0”, and outputs the information indicating that the recognizability is less than the threshold value, to the control unit 30 (Step ST35). The steps from Step ST23 to Step ST25 are the same as those in FIG. 6B, so that duplicative description thereof will be omitted.

When the virtual object is a navigation arrow as shown in FIG. 11, the recognizability determination unit 50 determines whether or not the head-side region in the arrow, as an important region, becomes the to-be-hidden region.

FIG. 13 is a diagram showing a situation where a head-side region in the arrow is determined to become the to-be-hidden region, by the recognizability determination unit 50. In this situation, the recognizability determination unit 50 sets the recognizability to the minimum value “0”, and outputs the information indicating that the recognizability is less than the threshold value, to the control unit 30.

On the other hand, FIG. 14 is a diagram showing a situation where the head-side region in the arrow is determined not to become the to-be-hidden region, by the recognizability determination unit 50. In this situation, the recognizability determination unit 50 sets the recognizability to the maximum value “100”, and outputs the information indicating that the recognizability is equal to or greater than the threshold value, to the control unit 30.

As described above, according to Embodiment 2, even if there is a to-be-hidden region, when the important region in the virtual object does not become the to-be-hidden region, the control unit 30 does not change the display form of the virtual object. As a result, it is possible to prevent the display form from being unnecessarily changed.

Further, according to the conventional hiding processing as disclosed in Patent Literature 1, when the characteristic region in a virtual object is deleted, the user can not accurately understand the information indicated by the virtual object. For example, in the case where the virtual object is a navigation arrow, when the head-side region in the arrow is deleted, the user can not understand a route to travel. In contrast, according to Embodiment 2, when the important region in a virtual object becomes the to-be-hidden region, the display form of the virtual object is changed. Thus, the characteristic region in the virtual object is prevented from being deleted.

### Embodiment 3

The configuration of a display control device 100 according to Embodiment 3 is the same as the configuration of the display control device 100 according to Embodiment 1 shown in FIG. 1, so that its illustration and description of the respective components will be omitted.

In Embodiment 3, the recognizability determination unit 50 calculates the recognizability of a virtual object on the basis of an area ratio before and after the hiding processing, of the virtual object. The recognizability determination unit 50 calculates the area of the virtual object and the area of the to-be-hidden region on the basis of the number of pixels, or the like, on the display screen of the display device 4.

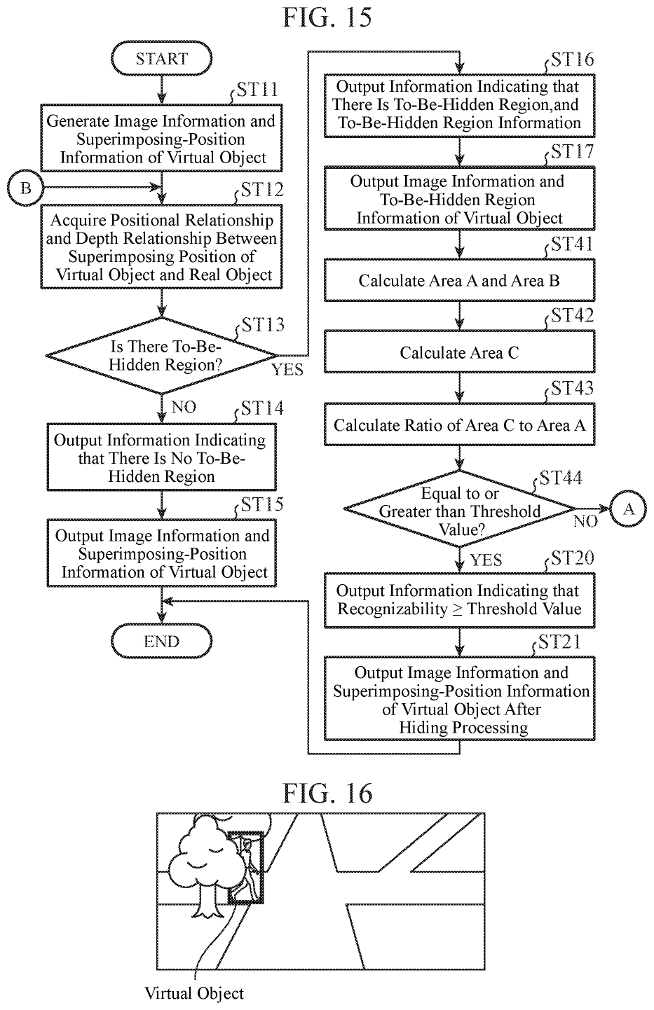

With reference to the flowchart shown in FIG. 15, virtual object generation processing to be performed by the display control device 100 according to Embodiment 3 will be described.

The steps from Step ST11 to Step ST17 are the same as those in FIG. 6A, so that duplicative description thereof will be omitted.

The recognizability determination unit 50, when the image information of the virtual object and the to-be-hidden region information are acquired from the control unit 30, calculates an area A of the virtual object before the hiding processing and an area B of the to-be-hidden region (Step ST41). The recognizability determination unit 50 calculates an area C of the virtual object after the hiding processing (Step ST42). The area C of the virtual object after the hiding processing is calculated by subtracting the area B from the area A.

The recognizability determination unit 50 calculates a ratio of the area C of the virtual object after the hiding processing to the area A of the virtual object before the hiding processing (Step ST43). The recognizability determination unit 50 defines the ratio of the area C to the area A as the recognizability of the virtual object after the hiding processing, and then determines whether or not the recognizability is equal to or greater than a predetermined threshold value (Step ST44).

The recognizability determination unit 50, when it is determined that the recognizability of the virtual object after the hiding processing is equal to or greater than the predetermined threshold value (Step ST44; YES), proceeds to the processing in Step ST20. Step ST20 and Step ST21 are the same as those in FIG. 6A, so that duplicative description thereof will be omitted.

On the other hand, when it is determined that the recognizability of the virtual object after the hiding processing is less than the predetermined threshold value (Step ST44; NO), the recognizability determination unit 50 proceeds to the processing in Step ST22 (FIG. 6B). The steps from Step ST22 to Step ST25 are the same as those in FIG. 6B, so that illustration and duplicative description thereof will be omitted.

FIG. 16 is a diagram showing a situation where the user uses a function of highlighting a nearby vehicle or a nearby pedestrian. The virtual object has a frame shape.

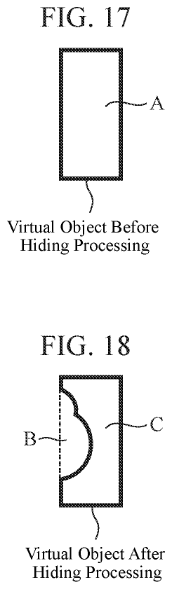

FIG. 17 is a diagram showing the area A of a virtual object before the hiding processing.

FIG. 18 is a diagram showing the area C of the virtual object after the hiding processing. Here, it is assumed that the area A is 500 and the area B is 100. In this case, the area C is 400. The recognizability determination unit 50 calculates the ratio of the area C to the area A, as (400/500)×100=80. The recognizability determination unit 50 defines the recognizability of the virtual object after the hiding processing as 80, and then determines whether or not the recognizability is equal to or greater than the predetermined threshold value.

As described above, in Embodiment 3, the recognizability of the virtual object is calculated using the area ratio between the area of the virtual object before the hiding processing and the area of the virtual object after the hiding processing. With this configuration, even when the virtual object has no characteristic region and thus the importance degrees of the respective regions in the virtual object are uniform, it is possible to determine whether or not the recognizability of the virtual object is equal to or greater than the predetermined threshold value.

In Embodiment 2, the configuration is described in which the importance degrees of the respective regions in the virtual object are used, and in Embodiment 3, the configuration is described in which the area ratio of the virtual object before and after the hiding processing is used; however, another configuration may be employed in which the above methods can be switched to be performed. In that case, whether to use the importance degrees of the respective regions in the virtual object, or to use the area ratio of the virtual object before and after the hiding processing is switched depending on the type or the like of the virtual object to be provided to the user.

### Embodiment 4

The configuration of a display control device 100 according to Embodiment 4 is the same as the configuration of the display control device 100 according to Embodiment 2 shown in FIG. 10, so that its illustration and description of the respective components will be omitted.

In Embodiment 4, the recognizability determination unit 50, when it is determined that the region with a high importance degree (important region) in the virtual object, that is acquired from the control unit 30, becomes the to-be-hidden region, calculates the recognizability of the virtual object after the hiding processing, on the basis of an area D of the important region in the virtual object before the hiding processing and an area F of the important region in the virtual object after the hiding processing.

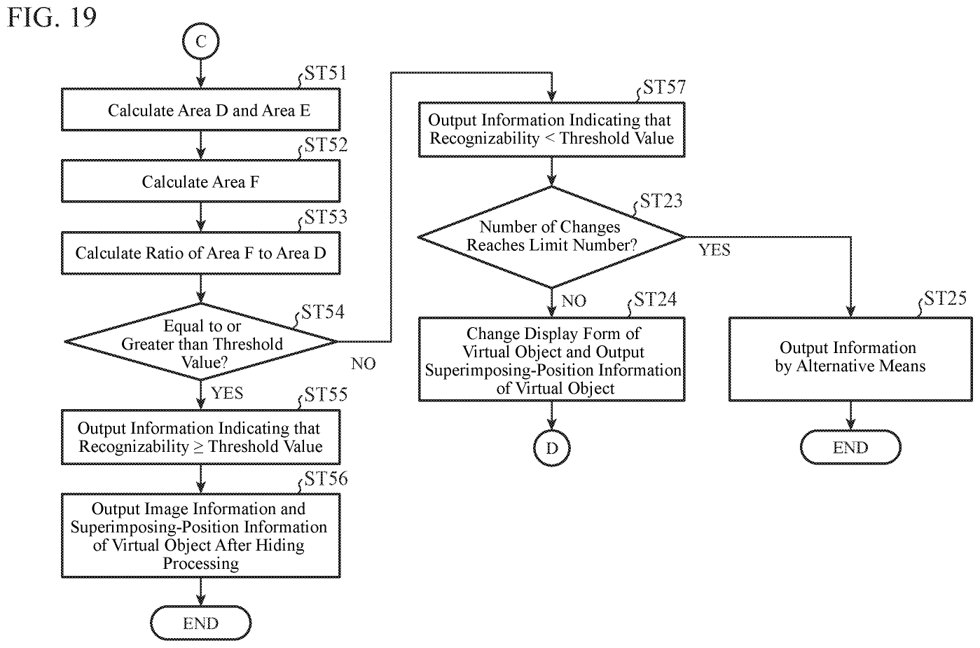

With reference to the flowchart shown in FIG. 19, virtual object generation processing performed by the display control device 100 according to Embodiment 4 will be described.

Note that the steps from Step ST11 to Step ST16, from Step ST31 to Step ST34, and Step ST21, are the same as those in FIG. 12A, so that illustration and duplicative description thereof will be omitted.

The recognizability determination unit 50, when it is determined that the important region in the virtual object becomes the to-be-hidden region (Step ST33; YES), calculates the area D of the important region in the virtual object before the hiding processing, and an area E of a region that is included in the important region of the virtual object and is matched to the to-be-hidden region (Step ST51).

The recognizability determination unit 50 calculates the area F of the important region in the virtual object after the hiding processing (Step ST52). The area F is calculated by subtracting the area E from the area D.

The recognizability determination unit 50 calculates a ratio of the area F to the area D in the case where the area D is set to 100 (Step ST53).

The recognizability determination unit 50 defines that ratio as the recognizability of the virtual object after the hiding processing, and then determines whether or not the recognizability is equal to or greater than a predetermined threshold value (Step ST54).

The recognizability determination unit 50, when it is determined that the recognizability of the virtual object after the hiding processing is equal to or greater than the predetermined threshold value (Step ST54; YES), outputs information indicating that the recognizability is equal to or greater than the threshold value, to the control unit 30 (Step ST55). In a case where the control unit 30 acquires, from the recognizability determination unit 50, the information indicating that the recognizability is equal to or greater than the threshold value, the control unit 30 outputs the image information of the virtual object after the hiding processing and the superimposing-position information of that virtual object, to the display device 4 (Step ST56).

The recognizability determination unit 50, when it is determined in Step ST54 that the recognizability of the virtual object after the hiding processing is less than the predetermined threshold value (Step ST54; NO), outputs information indicating that the recognizability is less than the threshold value, to the control unit 30 (Step ST57). The steps from Step ST23 to Step ST25 are the same as those in FIG. 12B, so that duplicative description thereof will be omitted.

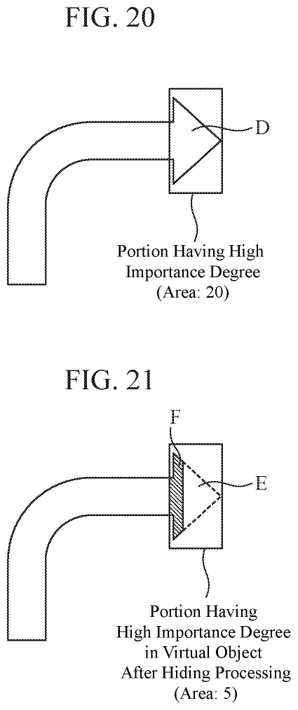

FIG. 20 is a diagram for illustrating the area D of an important region in a virtual object before the hiding processing.

FIG. 21 is a diagram for illustrating the area F of an important region in the virtual object after hiding processing.

The recognizability determination unit 50, when it is determined that the head-side region in the arrow becomes the to-be-hidden region, calculates the area D shown in FIG. 20 and the area F shown in FIG. 21. The recognizability determination unit 50 calculates the area F by subtracting the area E from the area D. Here, it is assumed that the area D is 20 and the area E is 15. In this case, the area F is 5. The recognizability determination unit 50 calculates the ratio of the area F to the area D, as (5/20)×100=25, to thereby define the recognizability of the virtual object after the hiding processing as 25, and then determines whether or not the recognizability is equal to or greater than the threshold value.

As described above, in Embodiment 4, the recognizability of the virtual object is determined using the area ratio of the important region in the virtual object between before and after the hiding processing. Accordingly, even if a to-be-hidden region is placed in the important region of the virtual object, when the ratio of the to-be-hidden region that occupies the important region is small, the display form of the virtual object is not changed. This makes it possible to prevent the display form from being unnecessarily changed.

### Embodiment 5

The configuration of a display control device 100 according to Embodiment 5 is the same as the configuration of the display control device 100 according to Embodiment 2 shown in FIG. 10, so that its illustration and description of the respective components will be omitted.

In Embodiment 5, on the basis of the importance degrees of the respective regions in the virtual object and the numbers of pixels (areas) in the respective regions, the control unit 30 calculates importance degrees of the respective pixels in the virtual object.

The recognizability determination unit 50 calculates the recognizability of the virtual object after the hiding processing, on the basis of the image information of the virtual object, the to-be-hidden region information and the importance degrees of the respective pixels in the virtual object.

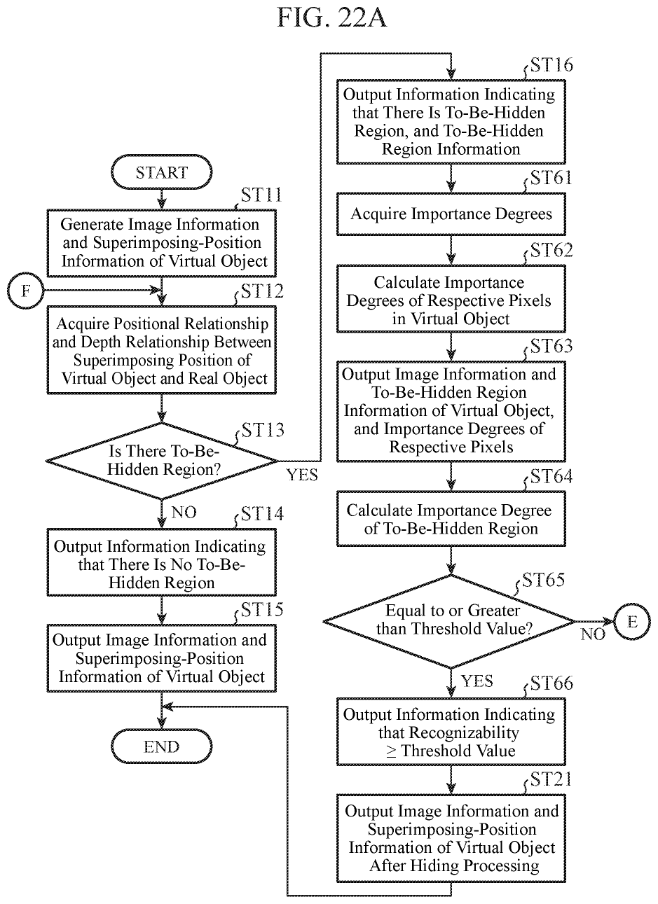

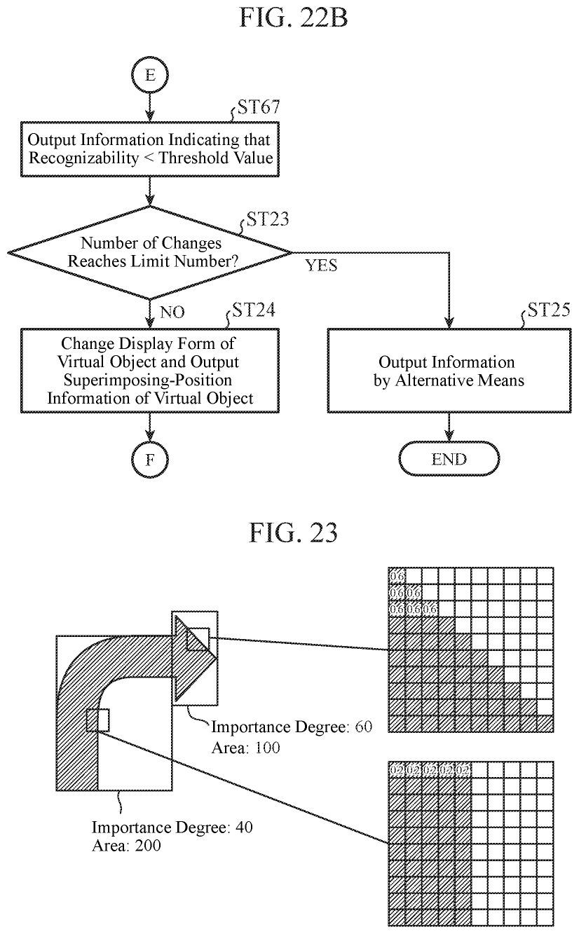

With reference to the flowcharts shown in FIG. 22A and FIG. 22B, virtual object generation processing performed by the display control device 100 according to Embodiment 5 will be described.

The steps from Step ST11 to Step ST16 are the same as those in FIG. 12A, so that duplicative description thereof will be omitted.

In a case where the control unit 30 acquires, from the to-be-hidden region acquisition unit 40, the information indicating that there is a to-be-hidden region and the to-be-hidden region information, the control unit acquires the importance degrees of the respective regions in the virtual object from the importance degree storage unit 60 (Step ST61).

The control unit 30 calculates a quotient by dividing the importance degree of each of the regions in the virtual object by the number of pixels constituting said each of the regions, to thereby calculate the importance degrees of the respective pixels in the virtual object (Step ST62).

FIG. 23 is a diagram for illustrating the importance degrees of the respective pixels.

When the virtual object is a navigation arrow, the control unit 30 acquires, from the importance degree storage unit 60, an importance degree of 60 for the head-side region in the arrow and an importance degree of 40 for the region in the arrow other than the head-side region. Here, if the number of pixels (area) in the head-side region in the arrow is 100 and the number of pixels (area) in the region in the arrow other than the head-side region is 200, the importance degree of each of the pixels constituting the head-side region in the arrow is 60/100=0.6, and the importance degree of each of the pixels constituting the region in the arrow other than the head-side region is 40/200=0.2.

The control unit 30 outputs the image information of the virtual object, the to-be-hidden region information and the importance degrees of the respective pixels in the virtual object, to the recognizability determination unit 50 (Step ST63).

The recognizability determination unit 50 calculates the importance degree of the to-be-hidden region, on the basis of the image information of the virtual object, the to-be-hidden region information and the importance degrees of the respective pixels in the virtual object (Step ST64). The recognizability determination unit 50 multiplies, by the number of pixels (area) in the to-be-hidden region, the importance degree for these pixels, to thereby calculate the importance degree of the to-be-hidden region. In this calculation, if the to-be-hidden region extends across multiple regions in the virtual object, the importance degree for the to-be-hidden region is calculated for each of the multiple regions, and the thus-calculated importance degrees for the to-be-hidden region are added together.

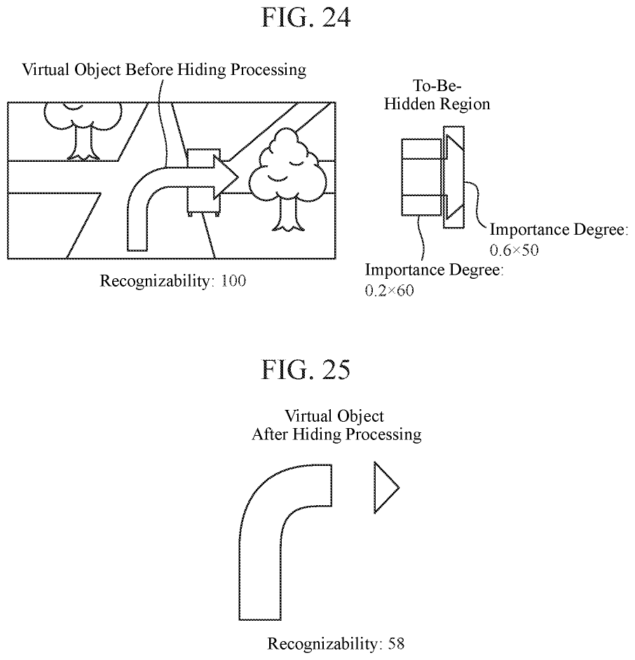

FIG. 24 is a diagram for illustrating importance degrees in the to-be-hidden region.

When a to-be-hidden region in the head-side region in the arrow has 50 pixels and a to-be-hidden region in the region in the arrow other than the head-side region has 60 pixels, the importance degree of the to-be-hidden region is (0.6×50)+(0.2×60)=42.

The recognizability determination unit 50 defines the value obtained by subtracting the importance degree of the to-be-hidden region from a predetermined maximum value of the recognizability, as the recognizability of the virtual object after the hiding processing, and then determines whether or not the recognizability is equal to or greater than a predetermined threshold value (Step ST65).

The recognizability determination unit 50, when it is determined that the recognizability of the virtual object after the hiding processing is equal to or greater than the predetermined threshold value (Step ST65; YES), outputs information indicating that the recognizability is equal to or greater than the threshold value, to the control unit 30 (Step ST66). Step ST21 is the same as that in FIG. 12A, so that duplicative description thereof will be omitted.

On the other hand, when it is determined that the recognizability of the virtual object after the hiding processing is less than the predetermined threshold value (Step ST65; NO), the recognizability determination unit outputs information indicating that the recognizability is less than the threshold value, to the control unit 30 (Step ST67). The steps from Step ST23 to Step ST25 are the same as those in FIG. 12B, so that duplicative description thereof will be omitted.

FIG. 25 is a diagram for illustrating the recognizability of the virtual object after the hiding processing.

Assuming that the recognizability of the virtual object before the hiding processing is 100, the recognizability of the virtual object after the hiding processing is 100−42=58.

As described above, in Embodiment 5, the recognizability of the virtual object is calculated on the basis of the values obtained by dividing the importance degrees of the respective regions in the virtual object by the areas of the respective regions, and the area of the to-be-hidden region. Since the recognizability is calculated not on the basis of the importance degrees of the respective regions in the virtual object, but on the basis of the importance degrees of the individual pixels, it is possible to further improve the accuracy of the recognizability. Accordingly, it is possible to determine more accurately whether or not the recognizability of the virtual object after the hiding processing is equal to or greater than the predetermined threshold value, to thereby prevent a virtual object from being displayed that is difficult for the user to recognize.

### Embodiment 6

The configuration of a display control device 100 according to Embodiment 6 is the same as the configuration of the display control device 100 according to Embodiment 2 shown in FIG. 10, so that its illustration and description of the respective components will be omitted.

In Embodiment 6, with the configuration of Embodiment 1, in a case where the control unit 30 acquires, from the recognizability determination unit 50, the information indicating that the recognizability is less than the threshold value, and determined that the number of times that the display form of the virtual object is changed does not reach a limit number, the following processing is performed.

The control unit 30 determines whether or not there is a region suitable for virtual object display.

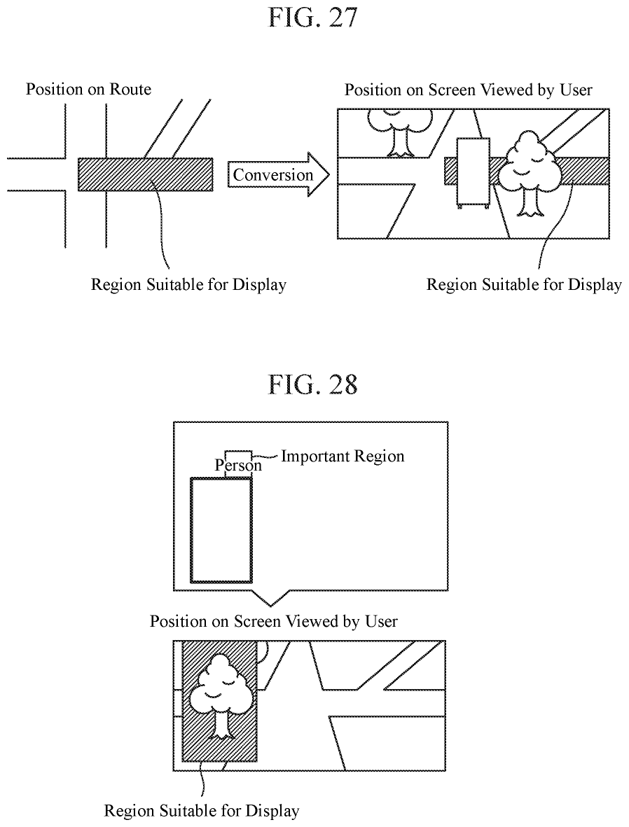

FIG. 27 is a diagram showing an example of a region suitable for virtual object display. When a user uses the navigation function, such a region that is placed on a road viewable by the user through the screen among the roads related to the navigating route and that is not interrupted by a real object, is provided as the region suitable for virtual object display.

FIG. 28 is a diagram showing another example of a region suitable for virtual object display. When a user uses the function of highlighting a nearby vehicle or a nearby pedestrian, such a region that is placed in a region around an object to be highlighted, that is viewable by the user through the screen and that is not interrupted by areal object, is the region suitable for virtual object display.

The control unit 30 divides the region suitable for virtual object display into multiple regions. Hereinafter, the respective regions thus divided are each referred to as a divided region. The control unit 30 specifies, among the divided regions, a region suitable for displaying an important region in the virtual object (hereinafter, referred to as an effective region).

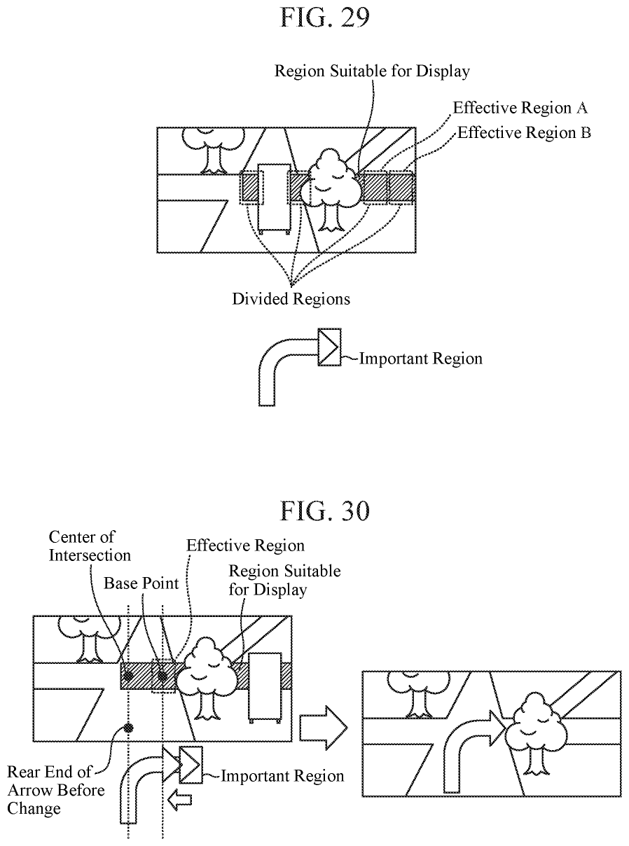

FIG. 29 is a diagram for illustrating a region (effective region) suitable for displaying an important region in a virtual object. The effective region is a divided region in which the display area of the important region in the virtual object (important region display area) is largest among the divided regions.

Note that the control unit 30 may specify plural effective regions by selecting them from among divided regions in which the important-region display areas are large, in a descending order of the important-region display areas. In that case, the control unit 30 stores the plural effective regions as data sorted in a descending order of the important-region display areas.

Further, the control unit 30 may specify, as the effective region, a divided region in which the important-region display area is largest among divided regions in which the important-region display areas are each a specific area or more.

Further, the control unit 30 may specify plural effective regions by selecting them from among divided regions in which the important-region display areas are each a specific area or more, in a descending order of the important-region display areas.

The control unit 30 generates a virtual object which is obtained by displacing the important region in the virtual object to the effective region.

Note that, FIG. 29 shows a case in which the control unit 30 specifies plural effective regions (an effective region A and an effective region B), and the important region display areas in the effective region A and the effective region B are the same. In this case, the control unit 30 selects the effective region A for which the displacement amount of the important region in the virtual object is the least, and generates a virtual object which is obtained by displacing the important region in the virtual object to the effective region A.

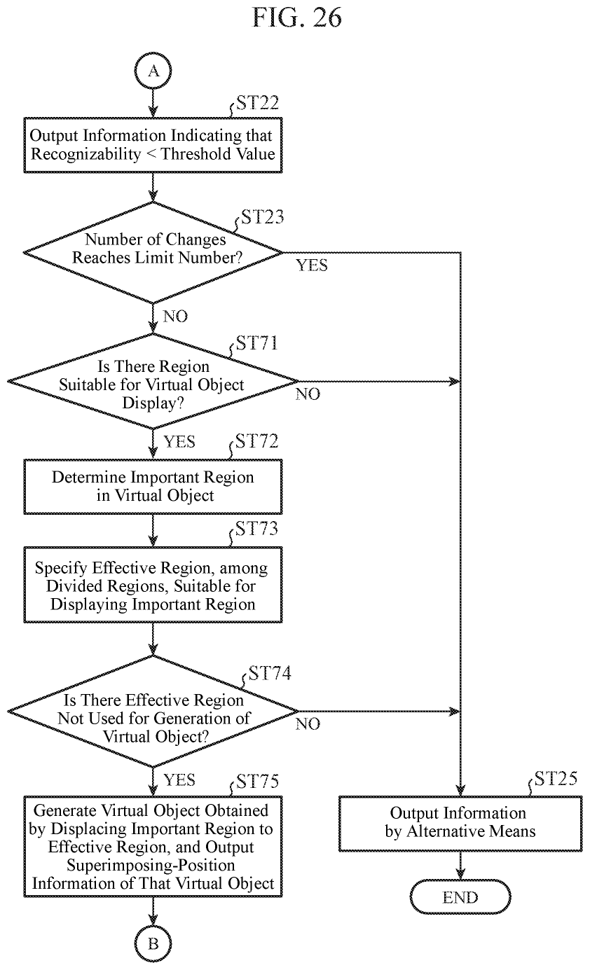

With reference to the flowchart shown in FIG. 26, virtual object generation processing performed by the display control device 100 according to Embodiment 6 will be described. Note that the steps from Step ST11 to Step ST21 are the same as those in FIG. 6A, so that illustration and duplicative description thereof will be omitted. Further, Step ST22, Step ST23 and Step ST25 are the same as those in FIG. 6B, so that duplicative description thereof will be omitted.

On the basis of the external information acquired from the external information acquisition unit and the positional information acquired from the positional information acquisition unit 20, the control unit 30 determines whether or not there is a region suitable for virtual object display (Step ST71).

When it is determined in Step ST71 that there is no region suitable for virtual object display (Step ST71; NO), the processing performed by the control unit 30 proceeds to Step ST25.

When it is determined in Step ST71 that there is a region suitable for virtual object display (Step ST71; YES), the control unit 30 acquires the importance degrees of the respective regions in the virtual object from the importance degree storage unit 60, and determines the important region in the virtual object (Step ST72).

Then, the control unit 30 divides the region suitable for virtual object display into multiple regions, and specifies, among the multiple regions (divided regions), a region(s) (effective region(s)) suitable for displaying the important region in the virtual object (Step ST73).

Then, the control unit 30 determines whether or not there is an effective region not used for generation (Step ST75 to be described later) of a virtual object (Step ST74).

When it is determined in Step ST74 that there is an effective region not used for generation of a virtual object (Step ST74; YES), the control unit 30 generates a virtual object which is obtained by displacing the important region in the virtual object to that effective region, and outputs the superimposing-position information of the thus-generated virtual object to the to-be-hidden region acquisition unit 40 (Step ST75). In Step ST75, when there are plural effective regions not used for generation of a virtual object, the control unit 30 uses the effective region in accordance with a priority in a descending order of the important-region display areas, for the generation of a virtual object. When the processing in Step ST75 is completed, the flow returns again to the processing in Step ST12 (FIG. 6A).

On the other hand, when it is determined in Step ST74 that there is no effective region not used for generation of a virtual object (Step ST74; NO), the control unit 30 proceeds to the processing in Step ST25.

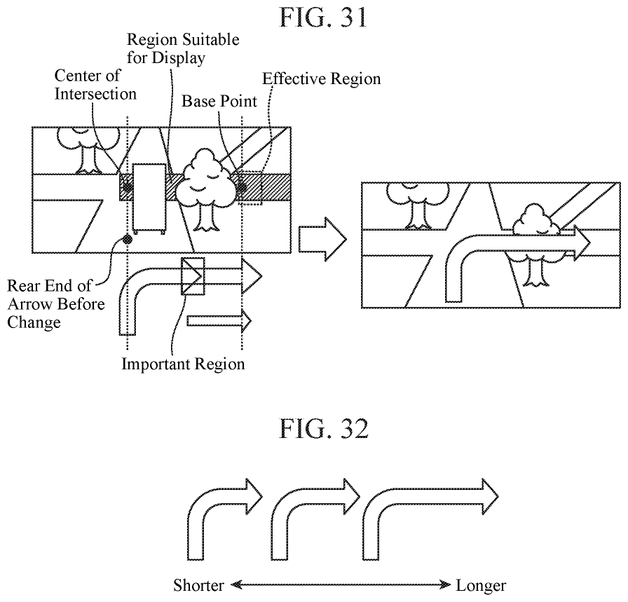

FIG. 30 is a diagram showing an example of how to displace the important region in the virtual object to an effective region. FIG. 31 is a diagram showing another example of how to displace the important region in the virtual object to an effective region. In FIG. 30 and FIG. 31, the virtual object is a navigation arrow. The control unit 30 displaces the head-side region (important region) in the arrow to an effective region. The control unit 30 defines as a first base point, a portion corresponding to a boundary between the head-side region in the arrow and the region in the arrow other than the head-side region; as a second base point, the center of the intersection; and as a third base point, a position corresponding to another end in the navigation arrow before being changed. The control unit 30 generates a navigation arrow so that the first base point, the second base point, and the third base point are connected by the navigation arrow.

In the above, in Step ST75, the control unit generates a virtual object which is obtained by displacing the important region in the virtual object to an effective region. Meaning of said “generates a virtual object” includes a case where multiple virtual objects having different display forms are prestored and then the control unit 30 selects a virtual object suited for display from among them.

FIG. 32 is a diagram showing an example of the prestored multiple virtual objects. In FIG. 32, multiple navigation arrows are shown in which the lengths of regions other than the head-side regions in the arrows are different to each other.

It is noted that, when the importance degrees of the respective regions in the virtual object are acquired until the processing in Step ST71, as exemplified by a case where the above configuration according to Embodiment 6 is applied to Embodiment 2, the processing in Step ST72 can be omitted.

As described above, in Embodiment 6, when the recognizability of the virtual object is less than the threshold value, a virtual object is generated which is obtained by displacing the important region in the virtual object to a region (effective region) which is one of regions suitable for virtual object display and in which the display area of the important region is largest. According to this processing, the possibility is increased that the recognizability of the virtual object becomes equal to or greater than the threshold value, in comparison with the case where the display form of the virtual object is changed with no such definition, when the recognizability of the virtual object is less than the threshold value. Thus, it is possible to prevent the display form from being unnecessarily changed. Further, when plural effective regions are specified, a virtual object is generated using the effective region in accordance with a priority in a descending order of the important-region display areas. Thus, it is possible to generate the virtual object efficiently. Further, when plural effective regions in which the important-region display areas are the same are specified, a virtual object is generated using the effective region for which the displacement amount of the important region is least. Thus, it is possible to generate the virtual object efficiently.

Lastly, hardware configuration examples of the display control device 100 will be described.

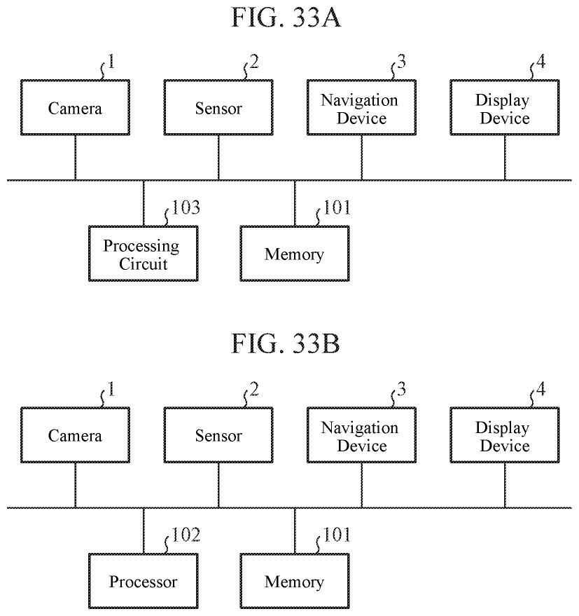

FIG. 33A and FIG. 33B are diagrams each showing a hardware configuration example of the display control device 100.

In the display control device 100, the respective functions of the external information acquisition unit 10, the positional information acquisition unit 20, the control unit 30, the to-be-hidden region acquisition unit and the recognizability determination unit 50 are implemented by a processing circuit. Namely, the display control device 100 includes the processing circuit for implementing the aforementioned respective functions. The processing circuit may be a processing circuit 103 as dedicated hardware, and may be a processor 102 which executes programs stored in a memory 101.

Further, the importance degree storage unit 60 in the display control device 100 is the memory 101. The processing circuit 103, the processor 102 and the memory 101 are connected to the camera 1, the sensor 2, the navigation device 3 and the display device 4.

When the processing circuit is dedicated hardware as shown in FIG. 33A, the processing circuit 103 corresponds to a single circuit, a composite circuit, a programmed processor, a parallel- programmed processor, an ASIC (Application Specific Integrated Circuit), an FPGA (Field Programmable Gate Array) or any combination thereof, for example. The functions of the external information acquisition unit 10, the positional information acquisition unit 20, the control unit 30, the to-be-hidden region acquisition unit 40 and the recognizability determination unit 50 may be implemented by plural processing circuits 103, and the functions of the respective units may be implemented collectively by one processing circuit 103.

When the processing circuit is the processor 102 as shown in FIG. 33B, the functions of the external information acquisition unit 10, the positional information acquisition unit 20, the control unit 30, the to-be-hidden region acquisition unit 40 and the recognizability determination unit 50 are implemented by software, firmware or a combination of software and firmware. The software and the firmware are each described as a program(s) and stored in the memory 101.

The processor 102 reads out and executes programs stored in the memory 101 to thereby implement the functions of the respective units. Namely, the display control device 100 includes the memory 101 for storing the programs by which, when they are executed by the processor 102, the respective steps shown in the flowcharts of FIG. 6A, FIG. 6B, FIG. 12A, FIG. 12B, FIG. 15A, FIG. 15B, FIG. 19A, FIG. 19B, FIG. 22A, FIG. 22B, FIG. 26A and FIG. 26B are eventually executed.

Further, it can also be said that these programs cause a computer to execute steps or processes of the external information acquisition unit 10, the positional information acquisition unit 20, the control unit 30, the to-be-hidden region acquisition unit 40 and the recognizability determination unit 50.

Here, the memory 101 may be a non-volatile or volatile semiconductor memory such as a RAM (Random Access Memory), a ROM (Read Only Memory), an EPROM (Erasable Programmable ROM), a flash memory or the like; may be a magnetic disk such as a hard disk, a flexible disk or the like; and may be an optical disc such as a CD (Compact Disc), a DVD (Digital Versatile Disc) or the like.

The processor 102 represents a CPU (Central Processing Unit), a processing device, an arithmetic device, a microprocessor, a microcomputer or the like.

It is noted that the respective functions of the external information acquisition unit 10, the positional information acquisition unit 20, the control unit 30, the to-be-hidden region acquisition unit 40 and the recognizability determination unit 50 may be implemented partly by dedicated hardware and partly by software or firmware. In this manner, the processing circuit in the display control device 100 can implement the aforementioned respective functions, by hardware, software, firmware or any combination thereof.

It should be noted that free combination of the respective embodiments, modification of any configuration element in the embodiments and omission of any configuration element in the embodiments may be made in the present invention without departing from the scope of the invention.

### INDUSTRIAL APPLICABILITY

The display control device according to the invention causes the information indicated by the virtual object to be presented accurately even when the hiding processing is performed on a region where the virtual object and the real object overlap each other, and is thus well-suited to being equipped in a vehicle or being brought into a vehicle.

### REFERENCE SIGNS LIST

1: camera 1, 2: sensor, 3: navigation device, 4: display device, 10: external information acquisition unit, 20: positional information acquisition unit, 30: control unit, 40: to-be-hidden region acquisition unit, 50: recognizability determination unit, 60: importance degree storage unit, 100: display control device.

1. A display control device controlling a display device that superimposes a virtual object on real scenery, comprising processing circuitry
to detect a real object existing in the real scenery;
to acquire, on a basis of a depth relationship between a superimposing position of the virtual object and the real object, and a positional relationship on a display screen of the display device between the superimposing position of the virtual object and the real object, a to-be-hidden region that is a region in the virtual object where the real object is to be placed in front of the superimposing position of the virtual object;
to calculate, by a recognizability determinator, a recognizability used for determining whether or not information indicated by the virtual object is recognizable when the to-be-hidden region is hidden, and to determine, by the recognizability determinator, whether or not the recognizability is equal to or greater than a threshold value; and
to generate, by a controller, when the recognizability is equal to or greater than the threshold value, another virtual object which is obtained by hiding the to-be-hidden region of the virtual object, and to generate, by the controller, when the recognizability is less than the threshold value, another virtual object which is obtained by changing a display form of the virtual object.

2. The display control device according to claim 1, wherein the virtual object includes multiple regions, and importance degrees are preset for the multiple regions, respectively; and
wherein, on a basis of the importance degrees, the recognizability determinator calculates the recognizability of the virtual object after processing of the hiding, and determines whether or not the recognizability is equal to or greater than the threshold value.

3. The display control device according to claim 1, wherein, on a basis of a ratio between an area of the virtual object before processing of the hiding and an area of the virtual object after processing of the hiding, the recognizability determinator calculates the recognizability, and determines whether or not the recognizability is equal to or greater than the threshold value.

4. The display control device according to claim 1, wherein the virtual object includes multiple regions, and importance degrees are preset for the multiple regions, respectively; and
wherein the recognizability determinator determines an important region in the virtual object on a basis of the importance degrees, calculates the recognizability on a basis of a ratio between an area of the important region before processing of the hiding and an area of the important region after processing of the hiding, and determines whether or not the recognizability is equal to or greater than the threshold value.

5. The display control device according to claim 1, wherein the virtual object includes multiple regions, and importance degrees are preset for the multiple regions, respectively; and
wherein the recognizability determinator calculates the recognizability on a basis of values, which are obtained by dividing the importance degree by area of region for each of the multiple regions, and an area of the to-be-hidden region, and determines whether or not the recognizability is equal to or greater than the threshold value.

6. The display control device according to claim 1, wherein the virtual object includes multiple regions, and importance degrees are preset for the multiple regions, respectively; and
wherein the controller, when the recognizability is less than the threshold value, determines an important region in the virtual object on a basis of the importance degrees, and generates a virtual object which is obtained by displacing the important region to a region which is one of regions suitable for virtual object display and in which a display area of the important region is the largest.

7. A display control method for controlling a display device that superimposes a virtual object on real scenery, comprising:
detecting a real object existing in the real scenery;
acquiring a to-be-hidden region that is a region in the virtual object where the real object is placed in front of a superimposing position of the virtual object, on a basis of a depth relationship between the superimposing positing of the virtual object and the real object, and a positional relationship on a display screen of the display device between the superimposing position of the virtual object and the real object;
calculating, by a recognizability determinator, a recognizability used for determining whether or not information indicated by the virtual object is recognizable when the to-be-hidden region is hidden, and determining, by the recognizability determination unit, whether or not the recognizability is equal to or greater than a threshold value; and
generating, by a controller, another virtual object which is obtained by hiding the to-be-hidden region of the virtual object when the recognizability is equal to or greater than the threshold value, and generating, by the controller, another virtual object which is obtained by changing a display form of the virtual object when the recognizability is less than the threshold value.

8. A display system comprising: a display device for superimposing a virtual object on real scenery; and a display control device for controlling the display device,
wherein the display control device comprises processing circuitry
to detect a real object existing in the real scenery;
to acquire, on a basis of a depth relationship between a superimposing position of the virtual object and the real object, and a positional relationship on a display screen of the display device between the superimposing position of the virtual object and the real object, a to-be-hidden region that is a region in the virtual object where the real object is to be placed in front of the superimposing position of the virtual object;
to calculate, by a recognizability determinator, a recognizability used for determining whether or not information indicated by the virtual object is recognizable when the to-be-hidden region is hidden, and to determine, by the recognizability determinator, whether or not the recognizability is equal to or greater than a threshold value; and
to generate, by a controller, when the recognizability is equal to or greater than the threshold value, another virtual object which is obtained by hiding the to-be-hidden region, and to generate, by the controller, when the recognizability is less than the threshold value, another virtual object which is obtained by changing a display form of the virtual object.
